(19) United States
(12) Patent Application Publication
(10) Pub. No.: US 2018/0189879 A1
(43) Pub. Date: Jul. 5, 2018

(54) Systems And Methods For Improving Electronic Futures Spread Exchange

(71) Applicant: Thomas Andersen, Chicago, IL (US)

(72) Inventor: Thomas Andersen, Chicago, IL (US)

(21) Appl. No.: 15/894,261

(22) Filed: Feb. 12, 2018

Related U.S. Application Data
(63) Continuation-in-part of application No. 13/917,230, filed on Jun. 13, 2013.

(51) Int. Cl. G06Q 40/04; H04L 12/18; G06Q 40/06

(52) U.S. Cl. CPC G06Q 40/04; G06Q 10/10; G06Q 40/06; H04L 12/1804

(57) ABSTRACT

The present disclosure relates to systems for creating an improved futures spread exchange for trading futures and futures option spread products. The present disclosures may include an exchange computer, vendors, customers, and a conversion device. The conversion device may convert quotes from various exchanges to a single denomination. The exchange, and its matching engine, may be accessed via a cloud network using an API interface. Multiple routes are provided for controlling the speed at which the matching engine may be accessed.

### RELATED APPLICATIONS

This patent application is a continuation in part of U.S. patent application Ser. No. 13/917,230, filed on Jun. 13, 2013 and currently pending, which claims priority to provisional Patent Application No. 61/658,570, filed on Jun. 14, 2012.

### BACKGROUND OF THE INVENTION

The present invention creates a futures exchange, futures spread products and futures spread options prodticts. More specifically, the present invention relates to a futures exchange that may list a variety of futures spreads and futures spread options (intra and inter market) instruments. These unique spreads may be created from ongoing price discovery generated at global exchanges but then converted into a tradable single currency product at the new exchange. The product may be cash settled and deliverable in the traded currency.

History has proven that start-up futures exchanges which compete head-to-head with incumbent exchanges and their established core products have a propensity to fail. For example, the Eurex U.S. and Cantor Fitzgerald exchange attempts were both failures. Prior start-up futures exchanges have initiated hostile business models that directly threatened either The Chicago Mercantile Exchange or the Chicago Board of Trade market share in major financial futures products such as Eurodollars or Treasury Notes. Additionally, unlike the New York Portfolio Clearing exchange, most also offer little, if any, product innovation. In the end, the exchange with the deepest franchise liquidity always survives.

Futures exchanges, unlike brokerage businesses, have been able to maintain almost protected profit margins supported not only by endless customers seeking liquidity and strong product brand but now also by Federal government regulations such as Dodd-Frank. Barriers to enter the exchange business appear to be insurmountable due to the complexities of government regulation and the position of incumbent exchanges. Eventually, free market initiative and viable product development can and will alter the exchange landscape.

### SUMMARY OF THE INVENTION

The present invention relates to a new all electronic exchange that: 1) lists global inter and intra market spreads, 2) converts the spread to single currency i.e. U.S. dollars, 3) publishes the spread in that single currency, i.e. U.S. dollars, 4) trades and settles those spreads in single currency, i.e. U.S. dollars, and 5) has a unique non-fee based transaction model. The exchange model of the present invention may attract customers of all origin—institutional, retail, market-makers and high-velocity.

The Global Futures Spread Exchange (GFS-X) may be a Designated Contract Market (DCM) regulated by the Commodity Futures Trading Commission, an independent agency of the U.S. government that regulates futures and options. The GFS-X instruments utilize some of the features of core markets from major exchanges such as the CME, CBOT, NYMEX, COMEX, LIFFE, EUREX, MATIF, ICE, and LME. The GFS-X offers inter and intra exchange single currency denominated cash value spreads and will have a fee structure whereas any market participant can benefit by providing liquidity (make) or for taking liquidity (take). The “make/take” fee structure is a first time U.S. futures industry pricing system, unique to the fee based exchange system prevalent globally today. The GFS-X unique dollar denominated spread instruments offer viable and unique trading “optionality” that will meet the criteria necessary to attract algorithmic, institutional, hedging and retail demand.

Unlike the driving force behind previous failed exchange, GFS-X instruments complement existing exchange traded products and add to the volume and liquidity at incumbent exchanges. The GFS-X pricing data relies on widespread market-making by liquidity providers based on other exchange pricing feeds. The outcome of this quoting structure is the tightest possible bid-offer spreads as underlying markets constantly shift.

GFS-X may engage an electronic central clearing house partner or group of partners such as Chicago Mercantile Exchange Group, OCC, NYSE, DTCC, MGEX or ICE to provide clearing, margining and risk for the GFS-X instruments. The GFS-X instruments offer less systemic risk to the financial system as they will naturally offer trades at a lower margin than what occurs today and may offset with core exchange products at the electronic central clearing house level. Risk offset that better leverages the capital of trading participants is paramount to trading activity contributing to exchange growth in today's capital markets. The trading world is in a position to support a new style of exchange that offers unique instruments in U.S. and foreign arbitrage contract constructions.

GFS-X may utilize a core listing of spread instruments that are European, Asian and American centric providing overlapping trading times. The listings may include inter-exchange futures spreads on U.S. short and longer term interest rate products such as Treasury Bonds, Treasury Notes, Eurodollars and foreign rate products such as Bunds, Bobl, Schatz, Euribor and Sterling as well as global stock indices replicating S+P 500, NASDAQ 100, German STOXX & DAX and the FTSE 100. Other immediate targets are energy, metals and agricultural products. The key is that the GFS-X converts, publishes, trades and settles all futures products in single currency, i.e. U.S. dollars.

Expiration cycles are based upon weekly, bi-monthly or quarterly cycles which mimic the trading and expiration cycles of underlying deliverable core futures products. Options on these instruments will also be constructed.

The primary goal of the GFS-X is to bring to market a global complementary set of trading instruments. GFS-X instruments will enhance the volume of established exchange core products while increasing participation and reducing risk. The intention is to minimize the barriers to exchange access through a new and unique exchange fee structure.

It is an object of the present invention to create a futures exchange based on domestic and foreign inter and intra exchange spreads. These instruments will trade the difference between products on multiple exchanges using a singular currency, i.e. U.S dollar. The instruments will be quoted by trading participants using current exchange contract prices converted into the deliverable currency, i.e. U.S dollars. Underlying examples by asset class would be interest rates, foreign currency, stock indices, agricultural and energy products.

It is a further object of the present invention to institute a U.S. futures industry first “make/take” transaction model in an open exchange environment where any type of customer would be eligible to participate.

Still yet another object of the present invention is to develop the exchange with another registered DCM or fund development of the exchange through private placement.

A further object of the present invention is to utilize an electronic central clearing house partner(s) that offer full facilities management in the margining, risk, technology and back-office needs of the exchange.

Another object of the present invention is the ongoing marketing and operational aspects of running the first exchange that trades futures spread instruments amongst and between major global futures contracts.

### DESCRIPTION OF THE DRAWINGS

Various other objects, features, advantages and benefits of the present invention will be more fully appreciated from the following detailed description of the preferred embodiment when considered in conjunction with the accompanying drawings:

FIG. 1 is a diagram of the entire Global Futures Spread Exchange system.

FIG. 2 is a further diagram of the entire Global Futures Spread Exchange system.

FIG. 3 is a diagram of the second embodiment of the Global Futures Spread Exchange system.

FIG. 4 is a schematic showing available order executing instructions and numerous global entry points into an exchange cloud network.

### DETAILED DESCRIPTION OF THE PREFERRED EMBODIMENT

Set forth below is a description of what are currently believed to be the preferred embodiments or best representative examples of the inventions claimed. Future and present representations or modifications to the embodiments and preferred embodiments are contemplated. Any alterations or modifications which make insubstantial changes in function, purpose, structure, or result are intended to be covered by the claims of this patent.

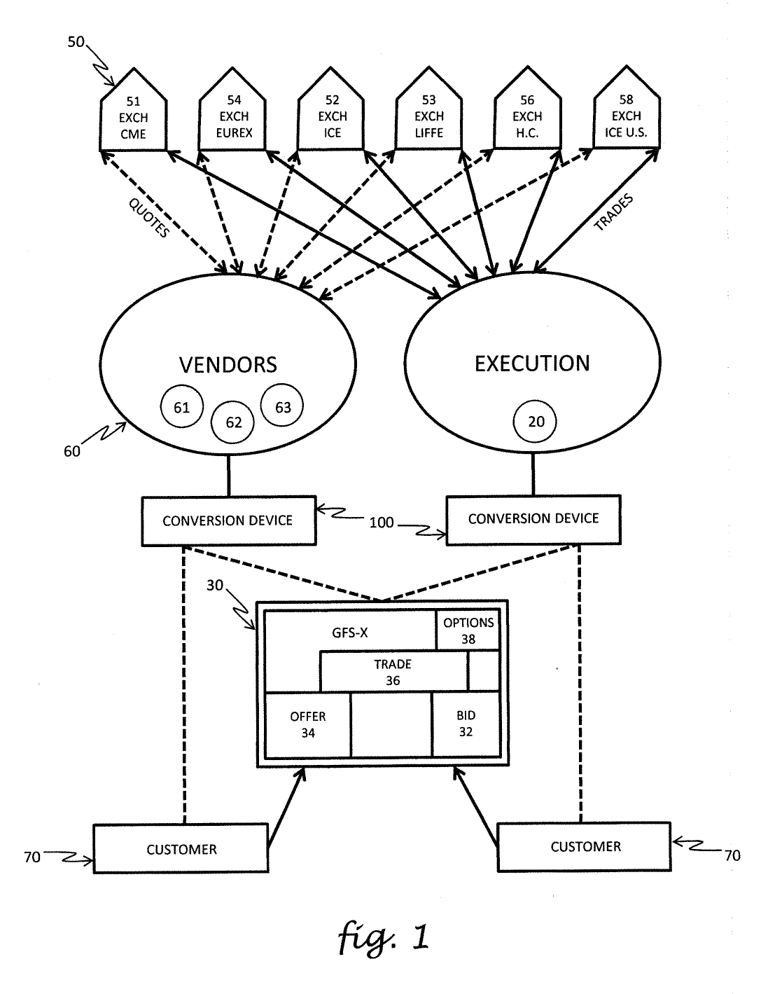

Referring to the drawings, and more particularly to FIG. 1, the GFS-X (30) system may include exchanges (50); vendors (60); customers (70), the GFS-X (30) and conversion devices (100).

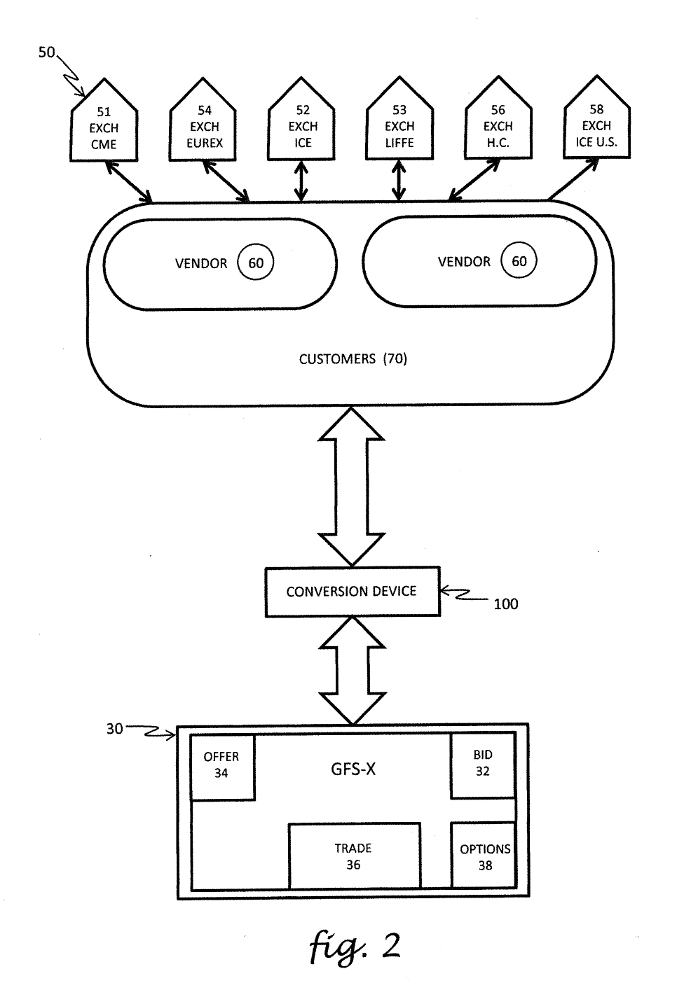

As can be seen in FIGS. 1 and 2, various exchanges (50) such as The Chicago Mercantile Exchange (51); Intercontinental Exchange (52); The New York Stock Exchange Liffe Exchange (53); Eurex Exchange (54); MGEX (56) and ICE U.S. (58) publicly distribute quotes provided by a market number. The quotes on the exchanges (50) are sent from the exchanges (50) to customers (70) or vendors (60). A vendor (60) is a service used by customers (70) to view quotes from the exchanges (50). Vendors (60) are typically charting tools and re-distributors of quotes. The exchanges (50) charge for quotes is typically passed on to the customers (70). An example of a vendor (60) includes Commodity Quote Graphics (CQG) or Bloomberg Tradebook. Alternatively, an exchange member customer could receive the quote directly from one or more of the various exchanges at very little, if any, cost. Another type of vendor may utilize offers exchange execution platforms to customer and member customers alike. These platforms and systems connect directly to the exchanges matching engine.

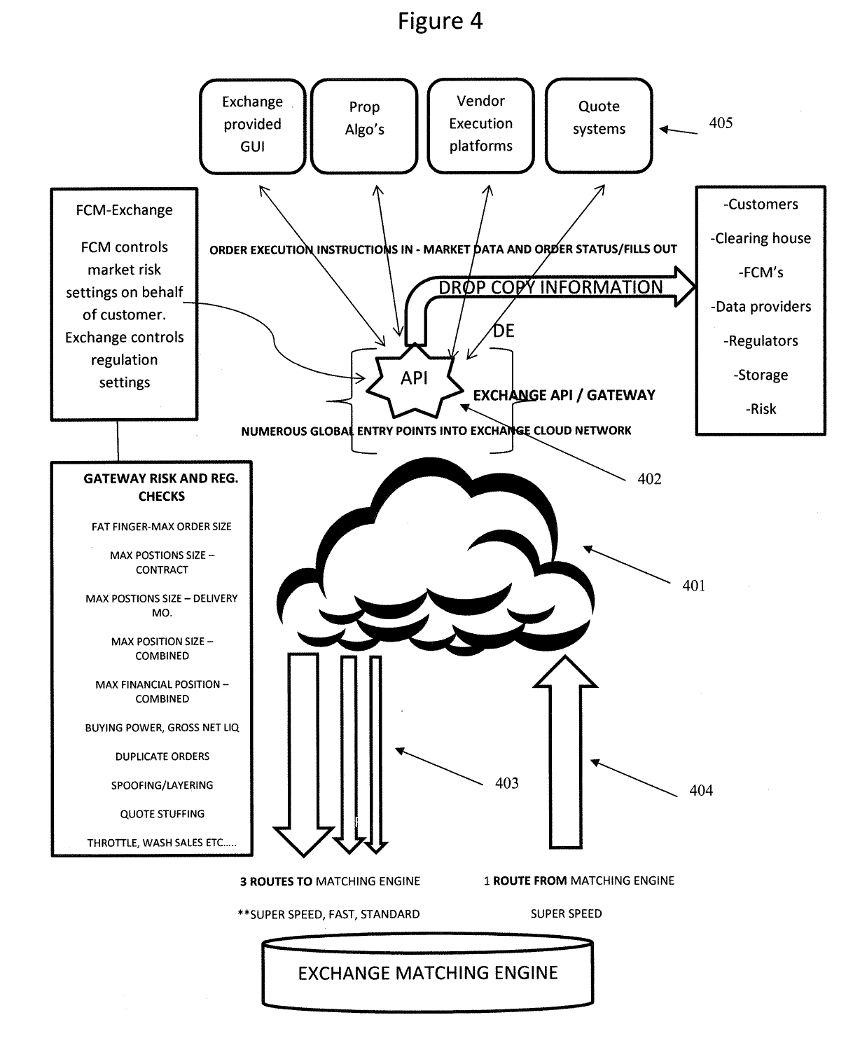

Connections to an exchange may be made via API (402) interface, where the API (402) provides a computer protocol allowing client machines to execute various functions on the exchange. An exemplary API (402) is shown in FIG. 4. The API (402) is installed on a client computer and interfaces via internet protocol with the matching engine. The API (402) creates an internet package. In particular, the API (402) may be a software component which takes inputs such as price, order type, duration, etc.

The matching engine receives quotes and displays “last sale price,” “bids/offers,” “quantity traded,” and “quantities on bids and offers.” A conversion device (100), which may be located at the quote vendor, execution platform, or customer level, immediately converts the quote sent from the various exchanges (50) to a single denomination, such as, by way of example, the U.S. Dollar.

A person of skill in the art would understand that some embodiments may include the conversion device, and other embodiments may achieve the same benefits without the conversion device. In embodiments where a conversion device is included, conversion device (100) may include a processor, a memory, and a communication component such as an ethernet card or a wireless card. In one example, the conversion device may be a virtual machine, in another example the conversion device may be a stand-alone device.

In embodiments of the invention, conversion device (100) is a tool that electronically provides a benchmark for spread prices that could potentially trade via outrights at incumbent exchanges (assuming spread has two legs):
buy leg1 on bid and sell leg2 on offer (best bid)
buy leg1 on bid and sell leg2 on bid (inside market)
buy leg1 on offer and sell leg2 on offer (inside market)
buy leg1 on offer and sell leg2 on bid (market)
sell leg1 on offer and buy leg2 on bid (best offer)
sell leg1 on offer and buy leg2 on offer (inside market)
sell leg1 on bid and buy leg2 on bid (inside market)
sell leg1 on bid and buy leg2 on offer (market)

Conversion device (100) may communicate with an exchange (50) via ethernet, Wi-Fi, or any other known internet protocol. The communication includes receiving quotes and storing them to memory. The conversion device's (100) processor may access the memory and immediately convert the receives quotes to a single denomination by multiplying the received quote by the current exchange rate. Moreover, conversion device (100) may be connected to a display, such as a computer monitor, on which the converted quotes are displayed for users to see.

The converted quote is then published to customers (70) who are interested participants in the Global Futures Spread Exchange (GFS-X) products (30). The customer (70) may have direct access to the GFS-X (30), or also may have access through one or more of the vendors (60), and has the ability to either buy or sell at the market (market taker) (32), or alternatively, to set the price by bidding or offering (market maker) (34) for a futures trade (36) in the single currency denominated spread products listed on the GFS-X (30).

If an offer to buy (market taker) (32) matches the offer to sell (market maker) (34) by a processor in communication with memory of the electronic trading platform, a contract or futures trade is executed (36) on the GFS-X using the single currency selected by the GFS-X exchange (30). The executed contract/trade is then sent into a process, such that the executed contract or trade (36) can be reported to an electronic central clearing house (20). In this way, the GFS-X (30) may offer a unique exchange platform for the execution of global spreads in a single currency which provides ease in clearing and margining at the electronic central clearing house and futures commission merchant (FCM) level.

Additionally, the GFS-X (30) may list options trading as part of the exchange. Options trading (38) on the GFS-X (30) is based on the underlying futures listed on the GFS-X (30). The GFS-X (30) will create an options series (39) or strike price based upon the underlying futures market places (36). The options portion of the exchange is a subset of the GFS-X (30) system.

The electronic central clearing house (20) may be a financial institution that provides clearing and settlement services for financial and commodities derivatives and securities transactions. A person of skill in the art would understand that existing electronic central clearing houses include computer hardware which may be accesses via a computer network.

The executed contract/trade is automatically electronically stored in memory of the electronic central clearing house; and by a processor in communication with memory of the electronic central clearing house, centrally clearing and settling the contract/trade by automatically electronically associating the centrally cleared contract/trade with a trading account associated with the first party and automatically electronically associating the centrally cleared and settled contract/trade with a trading account associated with the second party.

These transactions may be executed on a futures exchange or securities exchange, as well as off-exchange in the over-the-counter (OTC) market. A clearing house (20) stands between two clearing firms (also known as member firms or clearing participants) and its purpose is to reduce the risk of one (or more) clearing firms failing to honor their trade settlement obligations. A clearing house (20) reduces the settlement risks by netting off-setting transactions between multiple counterparties, by requiring collateral deposits (a.k.a. margin deposits), by providing independent valuation of trades and collateral, by monitoring the credit worthiness of the clearing firms, and in many cases, by providing a guarantee fund that can be used to cover losses that exceed a defaulting clearing firm's collateral on deposit.

Generally, the system operates in the following manner: Quotes are publicly distributed on one or more open exchanges which may trade using different currencies. Market makers use the quotes from the open exchanges to formulate underlying futures pricing and establish the spread price of the two instruments. The quotes from the open exchanges are converted to a single currency. This is published not only to customers but also on the GFS-X (30) exchange. The GFS-X (30) exchange displays the spread quote (38). The GFS-X (30) exchange also displays a bid offer (32) and (34). All of this is in a single currency. Customers on the GFS-X (30) exchange may execute a trade utilizing the last trade spread quote or on the bid or offer. The executed trade is then sent to a clearinghouse for settlement.

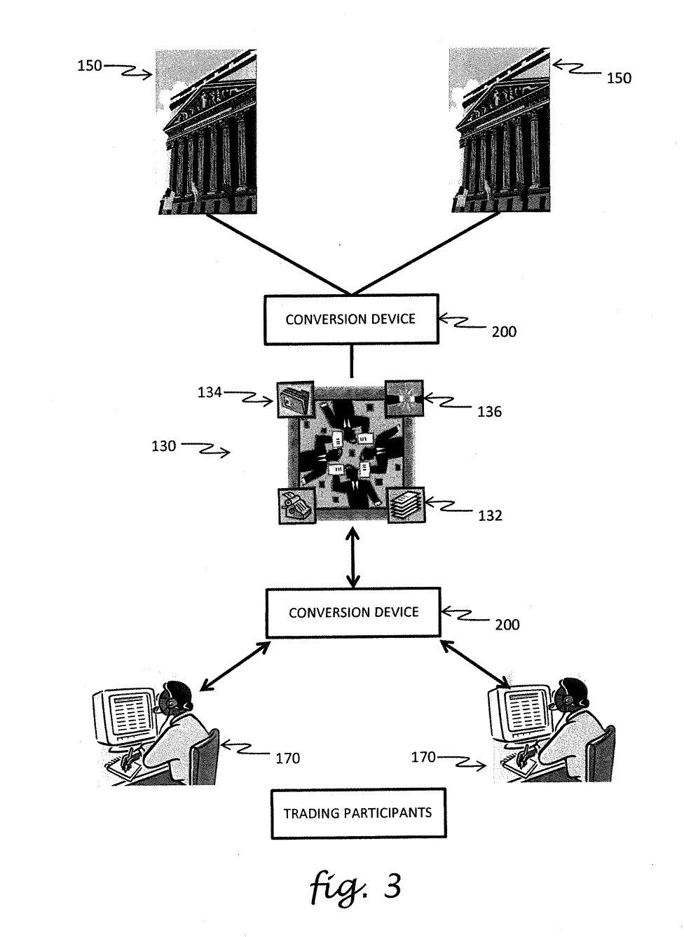

In FIG. 3, the GFS-X (130) is an exchange where trading participants may trade futures contracts; or more particularly spread instruments that are European, Asian or American and that may trade during overlapping time zones. The GFS-X (130) has several components. The GFS-X (130) contains Global Inter-Market Spreads; trades executed on the Global Inter-Market Spreads in a single currency, i.e. the U.S. Dollar; and will operate under a liquidity provision transaction model. The global spreads are converted using a conversion device (200) to a single currency, i.e. the U.S. dollars, prior to being inputted into the GFS-X (130).

The GFS-X (130) has a trade flow mapping functionality that may provide liquidity coding for the make-take, take-make model of executed instructions. The GFS-X (130) includes: (1) the commodity or futures trades being offered (134); (2) the futures bid (132); (3) the contract negotiated between the buyer and seller of the underlying futures contract (136); and (4) the exchange liquidity charge paid for delivery of the contract. The trading participants (170) can be either individuals or institutions. The trading participants may trade using a computer. The GFS-X (130) operates using a single currency. Therefore, all commodities or orders must be posted and executed on the exchange using the currency value after it has been converted from its original currency into the single currency utilized by the GFS-X (130). The GFS-X utilizes and displays the converted quotes and trades using or commodity using a single currency, i.e. U.S dollars.

The trading participant (170) “makes” a market by posting a bid or offer on the underlying futures contract (134) that he desires to trade on the GFS-X (130). The trading participant (170) that makes the market (134) sets a price and quantity willing to trade. The price (134) has been converted into single currency, i.e., U.S. dollars, by the conversion device (200). The price is converted to a single currency by a converter (200) prior to being entered into the GFS-X (130). Additionally, a market participant (170) may be interested in trading options on the GFS-X (130). The participant may publish a bid offer for an option on the GSF-X listed futures products.

Once a buyer (170) who makes the bid (134) and seller (170) who takes the bid (132) are matched within the GSF-X (130), a contract is made (136) and sent to the registered clearing house for trade and liquidity settlement whereas the market maker (134) is paid and the market taker (132) is charged for the trade.

In embodiments of the invention, the settlement price may be randomly determined, thereby avoiding the possibility of price manipulation. For example, sixty seconds prior to the closing of a given spread market, the matching processor may begin a time slice action wherein every fifteen second period prior to the close is stored in memory. Once the close occurs, each time slice will be run through a processor to determine a hypothetical closing price. The processor may be further configured to randomly assign a time slice. The activity within the randomly assigned time slice may be calculated using TWAP (time weighed average price); VWAP (volume weighted average price); High-low/2; or by using the last two trades of the period average price.

GFS-X (130) displays quotes by market makers (134) (any willing trading participant) (170) who will use underlying futures prices traded on incumbent global exchanges and when necessary, spot FX prices, converted to single currency, i.e. U.S. dollars and redisplayed as a spread quote with a bid-offer and size.

In its simplest form, once a quote leaves any incumbent futures exchange (150) and ends up at a paying customers location (170), through vendors such as CQG, Bloomberg or Trade Station or servers at co-location data centers for algorithmic trade computation, that customer (170) can interact with those paid for quotes any way that customer chooses, except redistribution. Therefore, the customer (170) can react to those prices by transacting back into the market where the quote came from or opt to react in another market. Additionally, that customer (170) can also convert that paid for quote into another product and make a market somewhere else. In effect, GFS-X (130) provides a platform for buyer (132) and seller (134) to meet in an efficient manner to trade bundled futures products not offered currently on any exchange.

Coupled with the unique GFS-X (130), the liquidity provision exchange transaction model as well as all the “optionality” the products will provide it, will become an exchange of choice for all trading participants (170) as futures markets continue to evolve through this decade and beyond.

A brief discussion of the exchange pricing model may prove helpful. Looking at FIGS. 1 and 2, the first is a Make-Take model. In a Make-Take model, the provider of liquidity (34) is paid, the remover of liquidity (32) is charged. The difference in the spread of the make and take is the exchange profit.

The second model is a Take-Make model. In a Take-Make model, the taker of liquidity (32) is paid, and the provider of liquidity is charged (34). Again, the difference in the spread of the make and the take is the exchange profit.

The third model is a Make-Take and Take-Make model. In a Make-Take and Take-Make model, the same principles apply as above for each with the difference being this model operates side by side within the same marketplace. Some trading participants may want this optionality in execution and it is a one size fits all model. Certainly quoting by trading participants will vary by model and arbitrage does exist between models. This would be a first to the futures trading world and not prevalent in any other market known at this time.

The GFS-X (130) leverages established markets that have high volume, actively traded contracts. The creation of these instruments inter-exchange and across continents will naturally create capital efficiency in margining and risk as the “spread alpha” captured is less volatile with a lower VAR than an outright bet.

The GFS-X (130) “make/take” pricing model is unique to the U.S. futures industry. As an example the “make/take single pricing model” incentivizes traders to post liquidity into the market. When a trading participant (134) or (34) “makes” a market and that market is traded (136) and (36), not only does the market maker receive the desired price, but the exchange cost to trade that GFS-X instrument is zero. In this same example, when a trading participant (132) or (32) “takes” liquidity on the GFS-X (130) and (30), either by hitting a posted bid (136) and (36) or lifting a posted offer, they are subject to the standard posted “take” fee. Although “taking” involves a charge—the bid-ask spread plus the take fee—there are many reasons why this still makes sense for a variety of GFS-X trading participants, including ease of entry and exit, reduced slippage, arbitrage potential, reduced execution risk and market inefficiencies between products.

The opposite works in the “take/make single pricing model” as takers of liquidity (132) and (32) are paid while providers (134) and (34) are charged. As expected, many trading participants may be more inclined to transact on this model and true liquidity providers will price the bid-offer differently, but the end result remains the same—if the spread becomes too out of line, other trading participants (170) will realize the value of aligning the spread by tightening the bid-offer (132) and (32). The underlying price of the futures is what drives the quotes, not the liquidity providers themselves.

The “make/take, take/make dual pricing model” will be a U.S. industry first as both models will trade side-by-side with one another in each contract market so that a trading participant can earmark what market to trade by pricing feature.

As an example of GFS-X: A money manager may be bullish U.S. interest rates to outperform German interest rates and is looking to the futures market to execute a trade that provides that exposure. Two options exist:

First, the market maker (134) or (34) may go to each individual market such as CME [10 Year Note] and Eurex [10 Year Bund] and execute the trade independently of one another which would involve risks, variation margining on two exchanges and expensive exchange fees.

Alternatively, the trading participant (134) or (34) can “make” a market in the futures exchange option for the 10 year inter-market spread, easily and quickly get market exposure as desired coupled with margin efficiency, all the while collecting exchange fees rather than paying. The futures exchange option for the 10 year market spread is sent to the GFS-X (130) or (30) and converted to U.S. Dollars by the conversion device (100) or (200) before it is posted on the GFS-X (130) or (30). The option is published in the exchange GFS-X (30) or (130) for a market taker (132) and (32) to bid or purchase.

The GFS-X (30) target audience is comprised of trading participants including, but not limited to, hedge funds, banks, algorithmic trading companies, institutions as well as the brokerage community—Broker Dealers (BDs) and Futures Commission Merchants (FCM's) and their retail customers. The first three listed trading participants are considered the most knowledgeable and actively trade the outright futures contracts aggressively on a daily basis. They will be the ones that will quickly recognize the benefits of leverage, cost and capital efficiency GFS-X offers.

Several examples of the trading using GFS-X are set forth below:

### Contract Construction Example

All instruments are quoted in dollars and by the dollar spread difference between each. For instance; Eurex 10 year Bund—CME 10 year Note futures instrument. By way of example, if the Eurex 10 year Bund price is bid 123.68 and the offer is 123.69, the bid valuation of 123,680 Euros is converted at the current FX rate to dollars—$172,515. The offer valuation of 123,690 Euros converted at current FX rate to dollars equals $172,529. Additionally, suppose the CME 10 year Note price bid is 121.085 and the offer is 121.090, the bid valuation—dollar value bid of $121,000+(8.5*$31.25) or $265.625 for a dollar bid value of—$121,265.625. The offer valuation—dollar value offer of $121,000+(9*$31.25) or $281.25 for a dollar offer value of $121,281.25.

To “make” liquidity and receive the rebate a trading participant would be on the bid side of one product and the offer side of another, for instance;

Bid side:
Bid the Eurex 10 year Bund at $172,515
Offer the CME 10 year Note at $121,281.25
The dollar value of buying German and selling U.S. 10 year rate spread would then equal $172,515-$121,281.25=$51,233.75 per instrument
Offer side:
Inversely, the same trading participant could also “make” liquidity by offering the same instrument, for instance:
Offer the Eurex 10 year Bund at $172,529
Bid the CME 10 year note at $121,265.625
The dollar value of selling German and buying U.S. 10 year rate spread would then equal $172,529−121,265.625=$51,263.375 per instrument.

The end result of the example is for the German/U.S. 10 year futures rate spread a liquidity provider would be a $51,233.75 bid and a $51,263.375 offer. These bids and offers will change dynamically as the underlying products change price and as the Euro FX component moves up and down, a core pricing feature to the GFS-X (30) instruments. Liquidity providers (market-makers) (142) and (34) use high speed technology to keep the spreads as tight as possible and liquidity takers (140) and (32) will use those tight spreads to reduce the dollar exposure of independent execution slippage. Accordingly, liquidity providers can and will become “takers” when the arbitrage amongst products turns profitable despite paying the take fee. Product pricing can also be normalized for easy quoting as explained in the following examples:

1) The above example could be a rounded 1/10 size or 5124-5126 as an example. Rounding also offers the opportunity, for competitive reasons and if business conditions warrant, to pay for “taking liquidity” rather than “making liquidity” as the rounding feature has imbedded “trader edge.”
2) For many markets where both spread legs have the same underlying contract multiplier despite different currencies, a spread price could be constructed by normalizing the decimals into dollars then subtracting both instruments thereby creating a natural dollar spread—for instance using a $1000 dollar multiplier and by using the same prices as illustrated above the CME 10 year note at 121.085 converts to a dollar price of $121,265.625 (with a $1000 multiplier the integer represents $121,000 thousand dollars and the 0.085 represents $31.25*8.5 or $265.625) and the Eurex Bund converts to $123,680 as again, using a $1000 multiplier the integer represents $123,000 and the decimal of 0.68 converts to 68*$10 or $680. Subtracted using the higher of the two legs the dollar spread equals $2414.375 ($123,680-$121,265.625). Inversely, by using the same calculation but implying the multiplier as 1000 Euros, the spread price is the same but in Eurocurrency. Both methods create the spread into one currency value leaving traders to hedge that currency exposure/risk on their own, or not. For simplicity, however, all examples used here discuss standard “make (rebate)-take (pay)” fee structures.

Embodiments of the invention may operate utilizing cash settled single currency, i.e. U.S. dollar, value delivery system whereby the market maker delivers the single currency value of the instrument on Last Trading Day while the market maker receives the value. In the case of a spread basis going negative to original value, the total of the positive and negative cash amounts will be tendered for delivery. All positions will be marked to the closing prices of the underlying core instruments at a yet to be determined time. FX values will also be marked at that time to take into consideration all dollar related events. Position limits should have the capability to be very large as the true underlying instrument is the single currency.

FIG. 4 is a schematic showing possible order executing instructions and numerous global entry points into an exchange cloud network (401). A person of skill in the art would understand that the cloud of FIG. 4 represents a cloud network through which API 402 can be connected to. The exchange cloud network (401) may be based on technology that 1) reduces infrastructure costs of trading participants 2) enables all customers a menu of “speed to market” capabilities determined by cost 3) “speed bumps” all order flow at gateway points for financial and regulatory risk checks and 4) generally, levels out or equalizes the technology playing field for all futures traders; retail, market-maker and institutional.

Also shown in FIG. 4 is the API 402 connected, via exchange cloud network 401, to an exchange matching engine via Routes (403), where Routes (403) may include pipelines of varying speeds, such as super fast, fast, and standard. A Return Route (404) which is directed to the cloud exchange network (402) is also provided. Moreover, API 402 may connect to a variety of clients (405) which include, without limitation, an exchange provided GUI, proprietary algorithms, vendor execution platforms, and quote systems.

For example, the exchange cloud network (401), from a trader's perspective, includes an execution point (i.e. exchange GUI, black box, ISV), at which the customer will determine which route the order will travel down once allowed into the network: exemplary options include super speed, fast or standard. The cost using the super speed or fast route may be reflected in a widening of the make-take pricing model at the exchange level. For instance, a fast route will widen the make-take to $0.65-$1.35, the super speed will widen it to $0.55-$1.45 and the standard is the exchange spread of $0.75-$1.25. These charges will map back from the matching engine into the FCM that will be clearing the trade so that daily reconciliation is possible.

Exemplary gateways may be established at telecom portals around the country such as NYC, Chicago, Portland, San Francisco, LA, KC, Houston, Dallas, Atlanta, etc. Each may be normalized for speed to the matching engine location. For instance, if the matching engine is located in a data center in KC, then a portal in Denver will have faster routes than a portal in NYC, therefore the routes in Denver may be slowed, so that access to the matching engine through the cloud network is equal.

Additional features of embodiments may include risk checks at these gateways, which may be both financial and regulatory. Additionally, advantages may be provided because outbound order history i.e. fills, status, cancels, changes etc., can be routed out at super speed. Embodiments disclosed herein may be favorable to regulators because all traffic in and out is highly scrutinized and that the exchange really may build out to specifications that make surveillance and oversight much easier for those in a watchdog position.

While aspects of the inventions have been described with reference to the preferred embodiments thereof, it will be appreciated that numerous variations, modifications, and alternate embodiments are possible, and accordingly, all such variations, modifications, and alternate embodiments are to be regarded as being within the spirit and scope of the invention.

It should be understood that various changes and modifications to the preferred embodiments described would be apparent to those skilled in the art. Changes and modifications can be made without departing from the spirit and scope of the present invention and without diminishing its intended advantages.

1. A computer-implemented system for creating and operating a futures spread exchange, comprising:
at least one exchange computer comprising at least one processor in operable communication with at least one memory and also in operable communication with at least one networking device;
the processor being configured to execute an application programming interface (API) for receiving order messages from a remote computer via the networking device;
a new futures contract, created by the processor and stored in the memory, having a neutral exchange value data based upon the spread between an event from a first open exchange and an event from a second open exchange; wherein the processor receives the event from the first open exchange and the event from the second open exchange via the networking device;
an independent exchange configured to use the neutral value exchange data of the new futures contract to generate a single currency spread product based upon the event from the first open exchange and second open exchange;
a matching engine configured to receive the order messages from the API and execute trades based on the order messages; and
a clearing house, connected to the matching engine via the network; which receives information about the executed trades.

2. The computer-implemented system of claim 1, further comprising a second processor configured to randomly determine the settlement price of the matching engine's executed trades.

3. The computer-implemented system of claim 2, wherein the second processor randomly determines the price by slicing a time interval of 60 second preceding the trade execution into four interval of 15 seconds each.

4. The computer-implemented system of claim 3, wherein the second processor is configured to randomly assign one time slice to be the executed trades' settlement price.

5. The computer-implemented system of claim 4, wherein the neutral value exchange data is determined by a computer conversion device, the computer conversion device being configured to convert the event from said first or second open exchange from a deliverable currency of said first or second exchange to the neutral exchange value.

6. The computer-implemented system of claim 5, wherein the neutral value exchange data of the new futures contract is established upon one open exchange that trades in treasury notes and another exchange that trades in monetary values.

7. The computer-implements system of claim 6, further comprising a monitor in operable communication with the processor, the monitor being configured to display the event from the first open exchange and the second open exchange.
